(19) United States
(12) Patent Application Publication
(10) Pub. No.: US 2025/0349962 A1
(43) Pub. Date: Nov. 13, 2025

(54) VEHICLE BATTERY PACK

(71) Applicant: SUBARU CORPORATION, Tokyo (JP)

(72) Inventors: Satoshi MURAKAMI, Tokyo (JP); Kazuhiro FUKAMACHI, Tokyo (JP)

(73) Assignee: SUBARU CORPORATION, Tokyo (JP)

(21) Appl. No.: 19/177,103

(22) Filed: Apr. 11, 2025

(30) Foreign Application Priority Data
May 8, 2024 (JP) 2024-076143

(51) Int. Cl. H01M 50/249; H01M 50/204; H01M 50/236; H01M 50/244

(52) U.S. Cl. CPC H01M 50/249; H01M 50/204; H01M 50/236; H01M 50/244; H01M 2220/20

(57) ABSTRACT

A vehicle battery pack mounted on a vehicle while accommodating batteries therein includes a battery case and a stiffened member. The battery case includes a frame member that is coupled to a rear portion of a sub-frame of the vehicle. The stiffened member has rigidity and is integrally coupled to a portion of the battery case. The stiffened member is disposed such that the stiffened member extends obliquely in a rear direction and a lateral direction of the frame member from a coupled portion between the sub-frame and the frame member, and that each end is coupled to the frame member.

### CROSS-REFERENCE TO RELATED APPLICATIONS

The present application claims priority from Japanese Patent Application No. 2024-076143 filed on May 8, 2024, the entire contents of which are hereby incorporated by reference.

### BACKGROUND

The disclosure relates to a structure of a vehicle battery pack used in a battery electric vehicle and the like.

In recent years, various types of electric vehicles (hereinafter also simply referred to as electric vehicles) have been in practical use and widely distributed. The electric vehicles include, for example, battery electric vehicles (BEVs), each of which travels while an electric motor mounted on the vehicle, such as an automobile, is driven by electrical energy stored in a battery pack.

This type of the BEVs may not include an engine (such as an internal-combustion engine (ICE)), which is a heavy component in vehicles. Instead, the battery pack that is twice or three-times heavier than the engine is mounted on the BEVs.

The battery pack that is applied to the electric vehicles includes, for example, a battery block (battery) having battery cells and a battery case in which the battery blocks (batteries) are accommodated side by side. In general, this battery pack is disposed below a cabin floor of the vehicle, for example.

By the way, it has been found that, in order to ensure favorable operating stability during vehicle travel, it is preferable that the heavy component (such as the engine or the electric motor) mounted on the vehicle follows vehicle behavior promptly, for example.

### SUMMARY

An aspect of the disclosure provides a vehicle battery pack mounted on a vehicle while accommodating batteries therein. The vehicle battery pack includes a battery case and a stiffened member. The battery case includes a frame member that is coupled to a rear portion of a sub-frame of the vehicle. The stiffened member has rigidity and is integrally coupled to a portion of the battery case. The stiffened member is disposed such that the stiffened member extends obliquely in a rear direction and a lateral direction of the frame member from a coupled portion between the sub-frame and the frame member, and that each end is coupled to the frame member.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic view illustrating a state where a vehicle battery pack in an embodiment of the disclosure is mounted on a vehicle.

FIG. 2 is a schematic exploded view of the vehicle battery pack in the embodiment of the disclosure illustrating each component.

FIG. 3 is a schematic view illustrating a result of a simple topology analysis performed on the vehicle, on which the battery pack in the embodiment of the disclosure is mounted.

FIG. 4 is a schematic view of the vehicle, on which the battery pack in the embodiment of the disclosure is mounted, seen from a lower surface side.

FIG. 5 is a schematic view illustrating a modified example of the battery pack in the embodiment of the disclosure.

FIG. 6 is a schematic view illustrating a modified example of the battery pack in the embodiment of the disclosure.

### DETAILED DESCRIPTION

Japanese Patent No. 7107139, Japanese Unexamined Patent Application Publication (JP-A) No. 2023-522474, and the like propose the following techniques related to configurations of the electric vehicles and the like. In the techniques, rigidity of a vehicle body and/or a set of a battery pack and a battery case is improved in consideration of a load transmission path from a suspension or the like to the battery pack or the battery case through various structures in the vehicle body, for example. However, when the load transmission path from the suspension or the like is extended, a possible delay occurs in follow-up of the vehicle behavior by the heavy component.

To handle such a problem, for example, U.S. Pat. No. 10,559,795 and the like disclose a battery pack configured to directly transmit the load received from the suspension or the like to the battery case by providing a brace between a cross member and each side rail to form the load transmission path.

However, suppression of a shock between the cross member and the battery pack, which is achieved by the technique disclosed in U.S. Pat. No. 10,559,795 and the like, is insufficient and thus has room for improvement.

For example, in a case of the electric vehicles, the battery is often disposed in a manner that weight of the battery, which is twice or three-times heavier than that of the engine, is concentrated below a floor. In this case, the battery weight often occupies about one-fourth of entire vehicle weight. Thus, the load transmission path from the suspension or the like, which is appropriately set, may have an impact on improvement in vehicle operating stability.

It is desirable to provide a vehicle battery pack, a structure of which is devised in consideration of a load transmission path from a suspension or the like and thus can contribute to improvement in vehicle operating stability.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

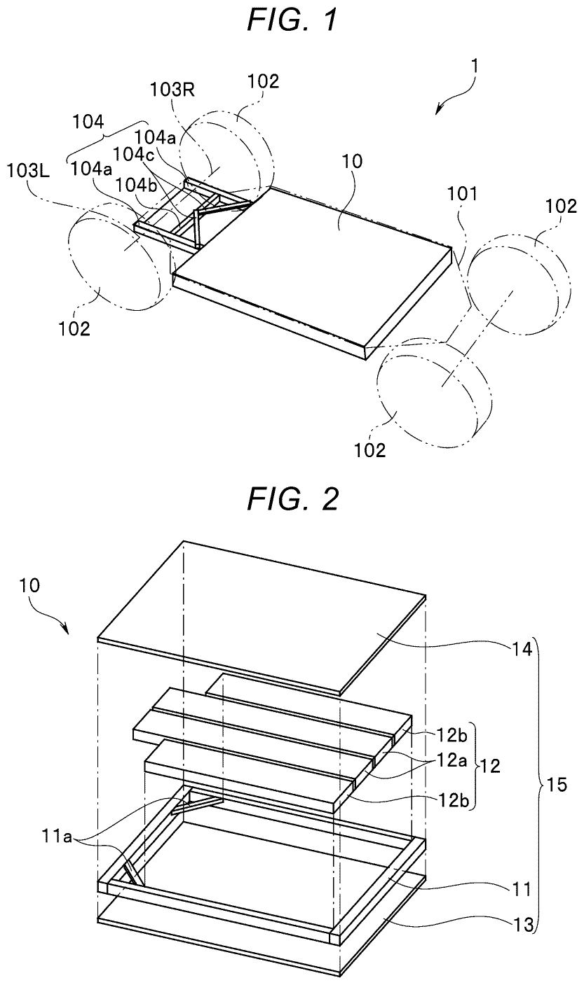

Hereinafter, a brief description will be made on a schematic configuration of a vehicle battery pack according to the embodiment of the disclosure with reference to FIG. 1 and FIG. 2. FIG. 1 is a schematic view illustrating a state where the vehicle battery pack in the embodiment of the disclosure is mounted on a vehicle. FIG. 2 is a schematic exploded view of the vehicle battery pack in the embodiment of the disclosure illustrating each component.

In FIG. 1, a vehicle battery pack (hereinafter simply referred to as a battery pack) 10 in this embodiment is mounted on a vehicle 1. The vehicle 1 is a four-wheeled automobile in a common form, and includes a floor panel 101, wheels 102, axles 103R, 103L, a sub-frame 104, frame members (not illustrated), a body (not illustrated), an electric motor (not illustrated), and the like.

The floor panel 101 is a plate member that forms a floor surface of the vehicle 1. The (basically four) wheels 102 are rotary members contributing to travel of the vehicle 1. The wheels 102 are usually provided near four corners of the vehicle 1.

The axles 103R, 103L are shaft members that transmit a driving force of the electric motor (not illustrated) as a drive source to respective drive wheels (two or more of the wheels 102). Accordingly, a base end of each of the axles 103R, 103L is coupled to a decelerator (not illustrated) provided to the electric motor (not illustrated). A distal end of each of the axles 103R, 103L is coupled to respective one of the two wheels 102 as the drive wheels. When the vehicle 1 is of a front-wheel-drive type, the drive wheels are the two right and left front wheels. When the vehicle 1 is of a rear-wheel-drive type, the drive wheels are the two right and left rear wheels.

With such a configuration, the vehicle 1 travels when the driving force of the electric motor is transmitted to the wheels 102 via the decelerator and the axles 103R, 103L. The illustrated example is a configuration example (front-wheel-drive type) in which the axles 103R, 103L are provided to the front wheels.

Such a configuration can also be adopted that the electric motors (not illustrated) are provided in front and rear portions of the vehicle to transmit the driving force to all the wheels that are the two front wheels and the two rear wheels. In this case, the vehicle 1 can travel as a four-wheel-drive vehicle.

The sub-frame 104 is a support member that supports suspensions (not illustrated) as shock absorbers of the vehicle 1, the electric motor (not illustrated), and the like. The sub-frame 104 is also a support member that positions the wheels 102 and the axles 103R, 103L.

Here, the sub-frame 104 constitutes a frame unit including two first frame members 104a, a second frame member 104b, and two third frame members 104c.

Of these frame members, the two first frame members 104a are each disposed to protrude to the front of the vehicle 1. In a substantially central region of the vehicle 1, the two first frame members 104a are disposed with a predetermined gap being provided therebetween in a lateral direction of the vehicle 1. As will be described below, a rear end of each of the two first frame members 104a is coupled to a predetermined portion of a frame member 11 of the battery pack 10.

At substantially intermediate positions of the two first frame members 104a in a front-rear direction, the second frame member 104b crosses between and couples the two right and left first frame members 104a.

The two third frame members 104c are disposed to obliquely extend toward an intermediate position of the second frame member 104b from base ends of the two first frame members 104a, respectively. In a front region of the frame member 11 of the battery pack 10, which will be described below, the sub-frame 104 is integrally coupled to the frame member 11.

Although not illustrated in FIG. 1, the frame members are a member group that includes frames or framing structural members as basic structural members of the vehicle. Similarly, although not illustrated in FIG. 1, the body is an exterior member of the vehicle 1 and constitutes one of the framing structural members of the vehicle 1.

The other components provided in the vehicle 1 are not directly related to the disclosure and thus neither illustrated nor described in detail. It is assumed that the other components are substantially the same as those applied to the common vehicle.

In the thus-configured vehicle 1, the battery pack 10 is fixed to a lower surface of the floor panel 101. This battery pack 10 is an energy source that supplies electrical energy to the electric motor.

As the vehicle 1, on which the battery pack 10 in this embodiment is mounted, a so-called electric vehicle, which is referred to as a battery electric vehicle (BEV) or the like, is assumed. The electric vehicle travels while the electric motor (not illustrated) is driven by the electrical energy stored in the battery pack 10.

The battery pack 10 includes battery blocks (batteries) 12a, 12b, each of which includes battery cells (not illustrated), and a battery case 15 in which the battery blocks 12a, 12b are accommodated side by side.

In the following description, a component in a form of unitizing the battery blocks 12a, 12b may also be referred to as a battery block group 12.

The battery blocks 12a, 12b, which constitute the battery block group 12 of the battery pack 10 exemplified in this embodiment, each have a rectangular parallelepiped shape with long sides in the front-rear direction of the vehicle 1. Of these, two battery blocks (batteries) that are disposed near a center of the vehicle 1 will be referred to as the first battery blocks (first batteries) 12a. Two battery blocks (batteries), each of which is disposed on respective one of both sides of the vehicle 1, will be referred to as the second battery blocks (second batteries) 12b.

In this case, entire longitudinal lengths of the second battery blocks 12b are slightly shorter than those of the first battery blocks 12a. A reason therefor will be described below.

A steering wheel is generally provided in a front region of the vehicle. Thus, the vehicle in a normal form is configured to secure a movable space for the steering wheel in both side regions in a front portion of the vehicle without disposing various structures. For this reason, also in the vehicle 1 exemplified in this embodiment, a movable region of the steering wheel is secured by slightly reducing the entire lengths of the second battery blocks 12b, each of which is disposed on the respective side of the vehicle 1.

The battery case 15 is a casing that includes the frame member 11, a bottom plate 13, and a lid plate 14. The frame member 11 constitutes an internal accommodation space that accommodates the battery block group 12, and is a frame-shaped structural member that is rigid and has a closed cross section in a substantially rectangular shape, for example. The frame member 11 is f formed in substantially rectangular frame shape in a manner to surround side surfaces of the battery block group 12.

Furthermore, stiffened members 11a are disposed at predetermined positions in the internal space of the frame member 11. These stiffened members 11a are rigid members, each of which has a rectangular closed cross-sectional shape. The stiffened members 11a are each integrally fixed to a portion of the frame member 11. Specific disposition of the stiffened members 11a will be described in detail below.

The bottom plate 13 is a thin plate-shaped member that covers an opening of a bottom surface of the frame member 11. The bottom plate 13 is disposed to cover the opening of the bottom surface of the frame member 11, and thereby constitutes a floor of the battery case 15. The lid plate 14 is a thin plate-shaped member that covers an opening of an upper surface of the frame member 11. The lid plate 14 is disposed to cover the opening of the upper surface of the frame member 11, and thereby constitutes a top of the battery case 15. With such a configuration, the battery case 15 has an internal space with a predetermined volume. In the internal space of this battery case 15, the battery blocks 12a, 12b are accommodated side by side.

Then, as described above, the battery case 15, in which the battery block group 12 is accommodated, is fixed to a lower side of the floor panel 101. In addition, in the battery pack 10, the sub-frame 104 is integrally coupled to a front portion of the frame member 11 of the battery case 15 (see FIG. 1).

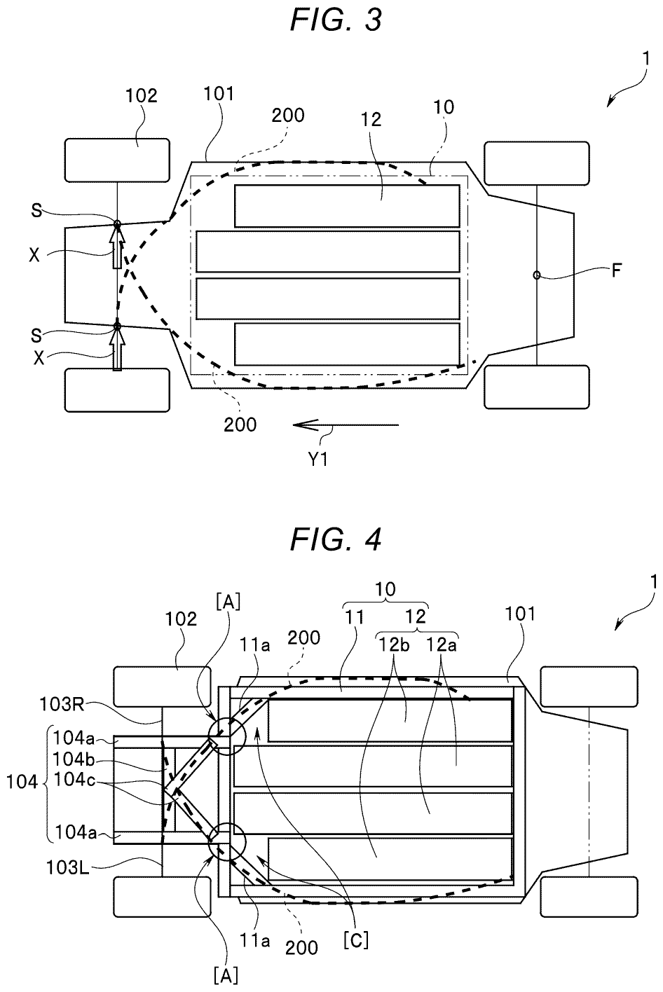

FIG. 3 is a schematic view illustrating a result of a simple topology analysis performed on the vehicle 1 in a state where the battery pack 10 in this embodiment is mounted. FIG. 3 illustrates a situation where the vehicle 1 is seen from the lower surface side. In FIG. 3, of the components of the battery pack 10, the bottom plate 13 and the lid plate 14 are not illustrated (the same applies to FIG. 4 to FIG. 6 described below).

A direction indicated by an arrow Y1 in FIG. 3 is the front direction of the vehicle 1. A load indicated by an arrow X in FIG. 3 is received by the suspension or the like during travel, such as a right turn, of the vehicle 1. At positions S, the load is received by the suspension or the like. In addition, a center position F is located between the right and left rear wheels.

When the load X is received at each of the load receiving positions S during the travel of the vehicle 1, for example, in an initial state of the right turn, the vehicle 1 receives a force in a direction of causing rotation about the center position F between the right and left rear wheels. At this time, the load X, which is received at each of the load receiving positions S, is then transmitted along a direction (chain line) 200 in FIG. 3. Here, a load transmission path 200 is illustrated.

Accordingly, in the battery pack 10 of this embodiment, as illustrated in FIG. 4, the stiffened members 11a are each disposed along the load transmission path 200, which passes through the inside of the battery pack 10, in a manner to be integrally coupled to the frame member 11. FIG. 4 is a schematic view of the vehicle, on which the battery pack in the embodiment of the disclosure is mounted, seen from the lower surface side.

The stiffened members 11a are each disposed by using a clearance space that is provided in a state where the battery block group 12 is accommodated in the internal space of the battery case 15. In one example, since the second battery blocks 12b, each of which is disposed on the respective side of the vehicle 1, is short, the stiffened members 11a are each disposed to pass obliquely across a clearance space [C] (see FIG. 4) provided in the battery case 15.

In other words, each of the stiffened members 11a is disposed to extend obliquely in the rear direction and the lateral direction of the frame member 11 from a coupled portion [A] (see FIG. 4) between a front member of the frame member 11 and respective one of the two first frame members 104a of the sub-frame 104. Then, each end of the stiffened members 11a is coupled to an inner surface on the respective side of the frame member 11.

Furthermore, as described above, the sub-frame 104 is integrally coupled to a front portion of the battery pack 10. Then, the third frame members 104c of the sub-frame 104 are disposed along the load transmission paths 200.

As it has been described so far, according to the battery pack 10 in the embodiment, the stiffened members 11a as the components of the battery pack 10 are disposed on the load transmission paths 200, through each of which the load received by the suspension or the like reaches the battery pack 10 via the sub-frame 104.

With such a configuration, when the load received by the suspension or the like is transmitted to the battery pack 10, the load can be transmitted directly from the sub-frame 104 to the battery pack 10 (the frame member 11 and the stiffened members 11a included therein) by avoiding the other structures as much as possible.

In this way, the battery pack 10, which is the heaviest object in the vehicle 1 as the electric vehicle, can promptly follow behavior of the vehicle 1. This contributes to improvement in vehicle operating stability.

Alternatively, the battery pack 10 in this embodiment can also be configured as the battery pack 10 having a specification without the stiffened members 11a being attached. In this case, larger battery blocks can be disposed on both of the sides of the vehicle 1 by using the clearance spaces where the stiffened members 11a are attached. As a result, by using the battery pack having the specification without the stiffened members 11a, a higher-capacity battery can be mounted, which enables longer-distance travel.

As described above, according to the configuration of the battery pack 10 in this embodiment, the battery pack 10 (having the specification illustrated in FIG. 4) and the battery pack (having the specification which the stiffened members 11a are not attached) can be easily manufactured by a simple process. The battery pack 10 is suited for a vehicle having a specification that emphasizes the operating stability, while the battery pack is suited for a vehicle having a specification that emphasizes the long-distance travel. Therefore, it is possible to provide the low-cost battery pack that can be easily suited for many types of the vehicles.

The battery pack in the embodiment of the disclosure is not limited to the configuration example as described above. Each of the following modified examples can also be considered.

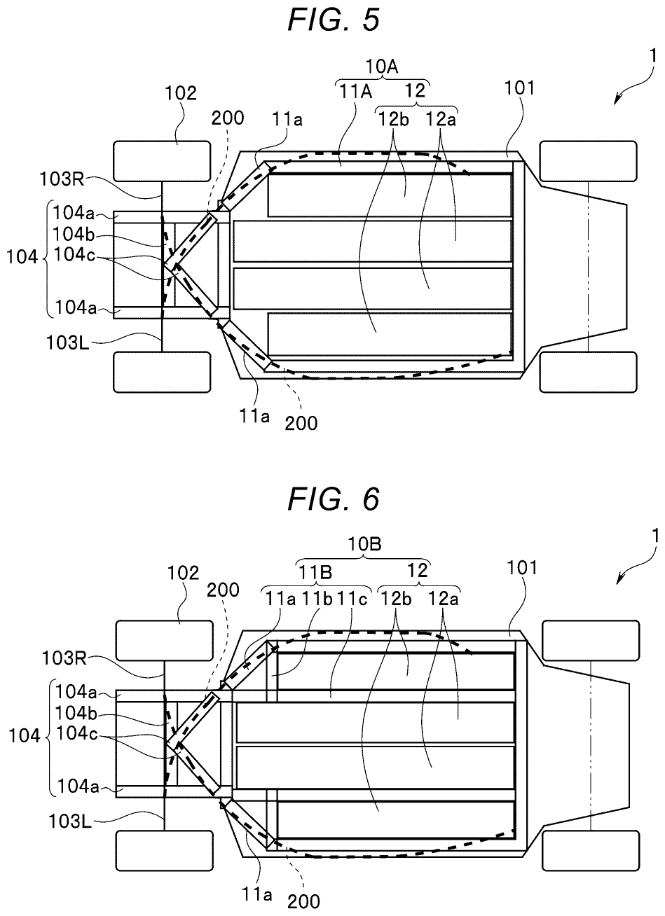

First, a description will be made on a first modified example of the battery pack in the embodiment of the disclosure. FIG. 5 is a schematic view illustrating the first modified example of the battery pack in the embodiment of the disclosure.

A configuration of the vehicle 1, on which a battery pack 10A in the first modified example is mounted, is basically the same as that in the embodiment illustrated in FIG. 4 above.

As illustrated in FIG. 5, a frame member 11A is in a different form from the frame member 11 of the battery pack 10 in the embodiment illustrated in FIG. 4, and is applied to the battery pack 10A in the first modified example.

The frame member 11A of the battery pack 10A in the first modified example is in such a shape that parts (front right and left corners) of the substantially rectangular frame shape of the frame member 11 in FIG. 4 are cut out. Then, the stiffened members 11a are disposed as members that constitute an outer periphery of the frame member 11A.

Similar to the embodiment described above, the sub-frame 104 is integrally coupled to a front portion of the thus-configured frame member 11A.

The battery pack 10A in the first modified example, to which the frame member 11A in the form as described above is applied, can exert the same effects as those in the embodiment described above. At the same time, while an outer size of the battery pack 10A itself is reduced, the battery block group 12 in exactly the same form as the battery block group 12, which is accommodated in the battery pack 10 of the embodiment, can be accommodated in the battery pack 10A. In this way, the battery pack 10A itself can be downsized without reducing an amount of power of the battery pack 10A. Therefore, it is also possible to contribute to downsizing of the vehicle 1, on which the battery pack 10A is mounted.

Next, a description will be made on a second modified example of the battery pack in the embodiment of the disclosure. FIG. 6 is a schematic view illustrating the second modified example of the battery pack in the embodiment of the disclosure.

A configuration of the vehicle 1, on which a battery pack 10B in the second modified example is mounted, is basically the same as that in the embodiment illustrated in FIG. 4 above or the first modified example illustrated in FIG. 5.

As illustrated in FIG. 6, a frame member 11B is in a different form from the frame member 11A of the battery pack 10A in the first modified example illustrated in FIG. 5, and is applied to the battery pack 10B in the second modified example.

In the frame member 11B of the battery pack 10B in the second modified example, forms of structural members that are provided on an outer periphery are substantially the same as those in the frame member 11A illustrated in FIG. 5. In the frame member 11B of the battery pack 10B in the second modified example, second stiffened members 11b and third stiffened members 11c are provided at predetermined positions in an internal accommodation space.

Of these, the second stiffened members 11b are each provided such that one end thereof is fixed to a base portion of the respective stiffened member 11a while the other end thereof extends toward an inner region of the frame member 11B in a direction perpendicular to a center line of the vehicle 1. Then, the other end of each of the second stiffened members 11b abuts the respective third stiffened member 11c described below and is integrally coupled to the respective third stiffened member 11c. In addition, the second stiffened members 11b are each disposed at a position at which the second stiffened member 11b abuts a front tip of the respective second battery block 12b. Thus, the second stiffened members 11b each have a function to position the respective second battery block 12b in the front-rear direction in the frame member 11B.

The third stiffened members 11c are each provided to extend rearward in a direction parallel to the center line of the vehicle 1 from the coupled portion between the frame member 11B and the respective first frame member 104a of the sub-frame 104. Then, a distal end of each of the third stiffened members 11c abuts a rear member of the frame member 11B and is integrally coupled to the frame member 11B. As a result, the third stiffened members 11c each have a function to position the respective first battery block 12a and the respective second battery block 12b in a right-left direction in the frame member 11B.

The battery pack 10B in the second modified example, to which the frame member 11B in the form as described so far is applied, can exert the same effects as those in the embodiment and the first modified example described above. At the same time, since it is configured to provide the second stiffened members 11b and the third stiffened members 11c in the frame member 11B, it can be configured that the load can be transmitted to side surfaces of the first battery blocks 12a, which are disposed near the center of the vehicle 1. Therefore, it is possible to constitute the highly rigid battery pack 10B, capability of which to follow the behavior of the vehicle 1 is further improved.

According to the disclosure, it is possible to provide the vehicle battery pack, the structure of which is devised in consideration of the load transmission path from the suspension or the like and thus can contribute to the improvement in the vehicle operating stability.

The disclosure is not limited to the above-described embodiment, and it is obvious that various modifications and applications can be made within the scope that does not depart from the gist of the disclosure. Furthermore, the above embodiment includes disclosures in various phases, and the various disclosures can be extracted by appropriate combinations of disclosed structural elements. For example, even when one or more structural elements are removed from all the structural elements described in the embodiment, the problem to be solved by the disclosure can be solved. In addition, when effects of the disclosure are exerted, the configuration, from which the one or more structural elements are removed, can be extracted as the disclosure. Moreover, the components in different embodiments may be combined appropriately. The disclosure is not restricted by any particular embodiment but restricted by the claims.

1. A vehicle battery pack mounted on a vehicle while accommodating batteries therein, the vehicle battery pack comprising:
a battery case comprising a frame member that is coupled to a rear portion of a sub-frame of the vehicle; and
a stiffened member that has rigidity and is integrally coupled to a portion of the battery case, wherein
the stiffened member is disposed such that the stiffened member extends obliquely in a rear direction and a lateral direction of the frame member from a coupled portion between the sub-frame and the frame member, and that each end is coupled to the frame member.

2. The vehicle battery pack according to claim 1, wherein
the stiffened member has a closed cross-sectional shape.

3. The vehicle battery pack according to claim 1, wherein
in a different specification in which the stiffened member is not provided, a high-capacity battery is accommodated in the battery case.

4. The vehicle battery pack according to claim 1, wherein
the stiffened member constitutes a part of the frame member.

5. The vehicle battery pack according to claim 1, wherein
each of the batteries have a shape with long sides in a front-rear direction of the vehicle,
the batteries comprise and a first battery disposed in a central region of the vehicle a second battery disposed on both sides of the vehicle, and the first battery has a long side that is longer than a long side of the second battery, and
in the battery case, the batteries are accommodated side by side in the lateral direction of the vehicle, the vehicle battery pack further comprising:
a second stiffened member that extends in the lateral direction of the vehicle from a base end of the stiffened member and is disposed parallel to a front end of the second battery; and
a third stiffened member that extends in the rear direction of the vehicle from the coupled portion between the sub-frame and the frame member and is disposed along the long side of the first battery.
